(19) United States
(12) Patent Application Publication
(10) Pub. No.: US 2025/0286264 A1
(43) Pub. Date: Sep. 11, 2025

(54) ELECTRONIC DEVICE AND CONFIGURING METHOD THEREOF

(71) Applicant: Lenovo (Beijing) Limited, Beijing (CN)

(72) Inventors: Yuling XU, Beijing (CN); Dafei MO, Beijing (CN)

(21) Appl. No.: 19/059,231

(22) Filed: Feb. 20, 2025

(30) Foreign Application Priority Data
Mar. 5, 2024 (CN) 202410251711.X

(51) Int. Cl. H01Q 1/22; H01Q 1/48; H01Q 1/50

(52) U.S. Cl. CPC H01Q 1/22; H01Q 1/48; H01Q 1/50

(57) ABSTRACT

An electronic device includes a first conductor and a second conductor, where the first conductor is a part of a housing of the electronic device, and the second conductor is another part of the housing of the electronic device; and a closed-loop gap is between the first conductor and at least a part of the second conductor, and the first conductor includes a feeding point and a first grounding point; and includes an antenna feeder, coupled with the closed-loop gap for feeding or in a direct contact with the feeding point for feeding, where the closed-loop gap is configured to radiate a radio frequency signal, and at least a part of the first conductor is configured to radiate a radio frequency signal.

### CROSS-REFERENCE TO RELATED APPLICATION

This application claims the priority of Chinese Patent Application No. 202410251711.X, filed on Mar. 5, 2024, the content of which is incorporated herein by reference in its entirety.

### TECHNICAL FIELD

The present disclosure generally relates to the field of electronic device technology and, more particularly, relates to an electronic device and a configuring method of the electronic device.

### BACKGROUND

With the development of electronic technology, the application of electronic devices and the integrated functions become more common. The communication performance of electronic devices is an important performance indicator of electronic devices. For example, the antenna in the electronic device is an apparatus configured to transmit or receive electromagnetic waves and plays a vital role in radio communication. Therefore, there is a need to improve the communication performance of electronic devices by improving antenna performance.

### SUMMARY

One aspect of the present disclosure provides an electronic device. The electronic device includes a first conductor and a second conductor, where the first conductor is a part of a housing of the electronic device, and the second conductor is another part of the housing of the electronic device; and a closed-loop gap is between the first conductor and at least a part of the second conductor, and the first conductor includes a feeding point and a first grounding point; and includes an antenna feeder, coupled with the closed-loop gap for feeding or in a direct contact with the feeding point for feeding, where the closed-loop gap is configured to radiate a radio frequency signal, and at least a part of the first conductor is configured to radiate a radio frequency signal.

Another aspect of the present disclosure provides an electronic device. The electronic device includes a first conductor and a second conductor, where the first conductor is the housing of the electronic device, and the second conductor is a functional module of the electronic device; and a closed-loop gap is between the first conductor and at least a part of the second conductor, and the first conductor includes a feeding point and a first grounding point; and includes an antenna feeder, fed with the closed-loop gap by coupling with the feeding point or by a direct contact with the feeding point, where the closed-loop gap is configured to radiate a radio frequency signal, and at least a part of the first conductor is configured to radiate a radio frequency signal.

Another aspect of the present disclosure provides a configuring method of an electronic device. The method includes configuring a first conductor and a second conductor, where the first conductor is a part of a housing of the electronic device, and the second conductor is another part of the housing of the electronic device, or the first conductor is the housing of the electronic device, and the second conductor is a functional module of the electronic device; and a closed-loop gap is between the first conductor and at least a part of the second conductor, and the first conductor includes a feeding point and a first grounding point; and providing an antenna feeder, coupled with the closed-loop gap for feeding or in a direct contact with the feeding point for feeding, where the closed-loop gap is configured to radiate a radio frequency signal, and at least a part of the first conductor is configured to radiate a radio frequency signal.

Other aspects of the present disclosure may be understood by those skilled in the art in light of the description, the claims, and the drawings of the present disclosure.

### BRIEF DESCRIPTION OF THE DRAWINGS

To clearly describe the technical solutions of various embodiments of the present disclosure, the drawings need to be used for describing various embodiments are described hereinafter. Obviously, the drawings in following description may be configured to merely describe some embodiments of the present disclosure. For those skilled in the art, other drawings may be obtained in accordance with the drawings without creative efforts.

The structures, proportions, sizes and the like illustrated in the drawings of the present disclosure may be merely configured to match the contents disclosed in the present disclosure for those skilled in the art to understand and may be not configured to limit the present disclosure, which may have no technical substantive significance. Any structural modifications, changes in proportion or adjustment of sizes, without affecting the functions and objectives achieved by the present disclosure, should still fall within the protection scope of the present disclosure.

FIG. 1 illustrates a structural schematic of an electronic device according to various embodiments of the present disclosure.

FIG. 2 illustrates another structural schematic of an electronic device according to various embodiments of the present disclosure.

FIG. 3 illustrates another structural schematic of an electronic device according to various embodiments of the present disclosure.

FIG. 4 illustrates another structural schematic of an electronic device according to various embodiments of the present disclosure.

FIG. 5 illustrates another structural schematic of an electronic device according to various embodiments of the present disclosure.

FIG. 6 illustrates another structural schematic of an electronic device according to various embodiments of the present disclosure.

FIG. 7 illustrates another structural schematic of an electronic device according to various embodiments of the present disclosure.

FIG. 8 illustrates another structural schematic of an electronic device according to various embodiments of the present disclosure.

FIG. 9 illustrates a principle schematic of an antenna in an electronic device according to various embodiments of the present disclosure.

FIG. 10 illustrates a curve diagram of an input reflection coefficient S11 parameter of an antenna in an electronic device according to various embodiments of the present disclosure.

### DETAILED DESCRIPTION

The technical solutions in embodiments of the present disclosure are clearly and completely described below with reference to accompanying drawings in embodiments of the present disclosure. Obviously, described embodiments are only a part of embodiments of the present disclosure, but not all embodiments. Based on embodiments in the present disclosure, all other embodiments obtained by those skilled in the art without creative efforts shall fall within the protection scope of the present disclosure.

At present, in order to improve the appearance texture, mechanical strength, anti-electromagnetic interference performance and heat dissipation performance of electronic devices, most electronic devices may use metal housings. The use of metal housings in electronic devices may improve above-mentioned various performances of electronic devices. However, the metal housings may have shielding effect on radiation signals of the antennas in the electronic devices, which may cause bandwidths of the antennas to become narrower to deteriorate performance, affect the performance of the antennas in the electronic devices, and further affect the wireless communication performance of the electronic devices.

To solve the influence of the metal housing on the antenna performance in the electronic device, a gap may be configured at the position of the metal housing corresponding to an antenna radiator, such that the antenna radiator may receive and transmit radio frequency signals based on the gap on the metal housing.

For the electronic device with folding function, such as a mobile phone, a laptop, a smart wearable device and/or the like, when the electronic device is in different folding states, the metal environment around the gap on the metal housing may have relatively large difference, which may cause the gap on the metal housing to be blocked by other parts of the metal housing in one or more folding states of the electronic device, thereby affecting the effect of the antenna receiving and transmitting radio frequency signals based on the gap in the metal housing and further affecting the performance of the antenna and the wireless communication performance of the electronic device.

Embodiments of the present disclosure provide an electronic device. The electronic device may include a first conductor, a second conductor, and an antenna feeder in the housing of the electronic device. A closed-loop gap may be between the first conductor and at least a part of the second conductor, and the first conductor may include a feeding point and a first grounding point. In the electronic device provided in embodiments of the present disclosure, on the one hand, the antenna feeder may radiate radio frequency signals based on the closed-loop gap; on the other hand, the antenna feeder may be electrically connected to a part of the electronic device forming the closed-loop gap, and the antenna feeder may be electrically connected to the feeding point of the first conductor, such that the antenna feed may also radiate radio frequency signals through at least a part of the first conductor. Therefore, the electronic device may radiate radio frequency signals based on at least a part of the first conductor when the closed-loop gap is blocked, which may reduce the influence on the antenna performance when the closed-loop gap is blocked and improve the antenna performance of the electronic device.

It should be noted that when the closed-loop gap is configured to radiate radio frequency signals, the closed-loop gap and the antenna feeder may be coupled for feeding; and in such scenario, the conductor forming the gap may not be connected to the antenna feeder but need to satisfy the coupling feeding. Another scenario is that the closed-loop gap and the antenna feeder may be directly and electrically connected for feeding; and in such scenario, the conductor forming the gap may be directly and electrically connected to the antenna feeder, that is, the conductor may be in contact with and connected to the antenna feeder. The present disclosure may not limit the electrical connection manner between the closed-loop gap and the antenna feeder; that is, those skilled in the art may adjust or configure the electrical connection manner according to actual needs.

It should be noted that the technical solutions provided in embodiments of the present disclosure may be modified and changed in various ways in the present disclosure without departing from the spirit or scope of embodiments of the present disclosure, which may be obvious to those skilled in the art. Therefore, the present disclosure may be intended to cover modifications and changes of the present disclosure that fall within the scope of corresponding claims (technical solutions need to be protected) and their equivalents. It should be noted that the implementation manners provided in embodiments of the present disclosure may be combined with each other without contradiction.

It should be noted that in embodiments of the present disclosure, the electronic device may be not limited to a foldable device but may also be a non-foldable device. When the electronic device is the non-foldable device, based on the technical solutions described in embodiments of the present disclosure, the electronic device may simultaneously radiate radio frequency signals based on the closed-loop gap and at least a part of the first conductor, such that the antenna performance and the wireless communication performance of the electronic device may be effectively improved compared to the antenna feeder radiating radio frequency signals based on one of the housing of the electronic device and the gap in the housing.

Furthermore, in embodiments of the present disclosure, the electronic devices may include but may be not limited to mobile phones, laptop computers, and smart wearable devices and the like and may also be other types of electronic devices with wireless communication functions. The forms of the electronic devices may be not limited in embodiments of the present disclosure.

In order to clearly understand above-mentioned objectives, features and advantages of the present disclosure, the present disclosure is further described in detail in combination with accompanying drawings and embodiments.

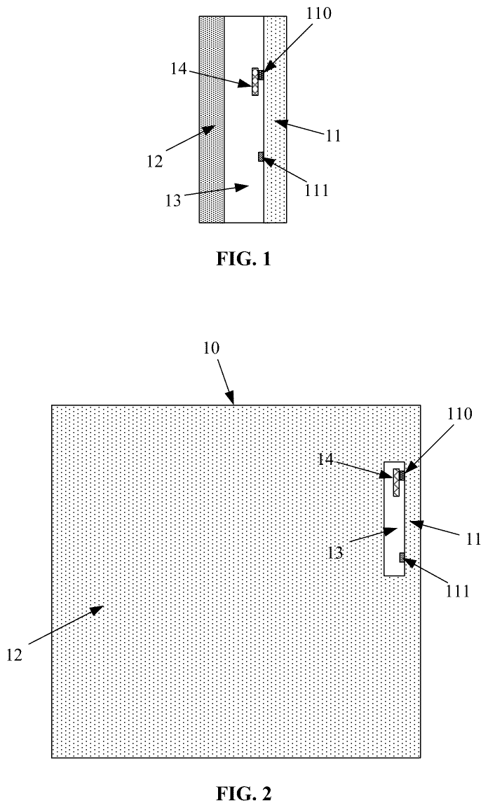

Referring to FIG. 1, FIG. 1 illustrates a structural schematic of an electronic device according to various embodiments of the present disclosure. The electronic device may include a first conductor 11 and a second conductor 12. The first conductor 11 may be a part of the housing of the electronic device, and the second conductor 12 may be another part of the housing of the electronic device; or the first conductor may be the housing of the electronic device, and the second conductor may be a functional module of the electronic device. A closed-loop gap 13 may be between the first conductor 11 and at least a part of the second conductor 12; and the first conductor 11 may include a feeding point 110 and a first grounding point 111. The electronic device may further include an antenna feeder 14. The antenna feeder 14 may be electrically connected to a part of the electronic device forming the closed-loop gap 13. The closed-loop gap 13 may be configured to radiate radio frequency signals. The antenna feeder 14 may be electrically connected to the feeding point 110. At least a part of the first conductor 11 may be configured to radiate radio frequency signals.

In one embodiment, the antenna feeder may be coupled with the closed-loop gap for feeding or in a direct contact with the feeding point for feeding, where the closed-loop gap may be configured to radiate a radio frequency signal, and at least a part of the first conductor may be configured to radiate a radio frequency signal.

The closed-loop gap 13 may be between the first conductor 11 and at least a part of the second conductor 12, and the antenna feeder 14 may be electrically connected to the feeding point 110, such that the electronic device may include a first radiator and a second radiator. The electronic device may form two radiators based on same antenna feeder 14, and the two radiators may be the first radiator and the second radiator respectively. The first radiator may include the antenna feeder 14 and the closed-loop gap 13 and radiate radio frequency signals based on the closed-loop gap 13. The second radiator may include the antenna feeder 14 and at least a part of the first conductor 11 and radiate radio frequency signals based on at least a part of the first conductor 11. Therefore, the electronic device may radiate radio frequency signals based on the first radiator and the second radiator simultaneously, which may reduce the influence on the antenna performance in the electronic device when the closed-loop gap 13 is blocked and improve the wireless communication performance of the electronic device.

In embodiments of the present disclosure, the closed-loop gap 13 may not need to have a fixed shape and position. The closed-loop gap 13 may be configured with a fixed shape and position based on appearance requirement of the electronic device housing 10, such that the electronic device may have a desirable appearance, thereby improving the user experience and product competitiveness.

In embodiments of the present disclosure, the electronic device may be a foldable device. When the electronic device is the foldable device, the influence on the antenna performance when the closed-loop gap 13 is blocked due to certain folding positions may be avoided, such that the electronic device may meet the wireless communication performance under various folding position requirements without considering the influence of the folding positions on the antenna performance.

The electronic device may also be a non-folding device. When the electronic device is the non-folding device, the electronic device may be a double-sided screen device or a full-screen device.

In an implementation manner of the present disclosure, the radio frequency signal radiated by the closed-loop gap 13 may be configured to be at same frequency band as the signal radiated by the first conductor 11; that is, the closed-loop gap 13 may radiate the radio frequency signal of same frequency band as the first conductor 11. In such implementation manner, the first radiator and the second radiator may radiate the radio frequency signals of same frequency band; and the electronic device may radiate radio frequency signals of same frequency band based on the first radiator and the second radiator simultaneously, thereby enhancing the radiation intensity and stability of the radio frequency signals of the frequency band by the electronic device. When there is an interference signal of the radio frequency signals of the frequency band in external environment, based on above implementation manner, the intensity of the radio frequency signals of the frequency band radiated by the electronic device may be enhanced, thereby reducing the interference level of the interference signal to the radio frequency signals of the electronic device in the frequency band.

In an implementation manner of embodiments of the present disclosure, the radio frequency signal radiated by the closed-loop gap 13 and the signal radiated by the first conductor 11 may also be configured to different frequency bands; that is, the closed-loop gap 13 and the first conductor 11 may radiate radio frequency signals of different frequency bands. In such implementation manner, the first radiator and the second radiator may radiate radio frequency signals of different frequency bands; and the electronic device may radiate radiation signals of different frequency bands based on the first radiator and the second radiator. In such way, the electronic device may perform wireless communication in a wider frequency band, which may improve the communication bandwidth of the antenna in the electronic device; and the electronic device may support more communication protocols and services without occupying additional layout space of the electronic device.

As described above, based on the technical solutions of embodiments of the present disclosure, the communication bandwidth may be improved. For example, for antennas in the WLAN frequency band, the technical solutions of embodiments of the present disclosure may enable the antenna of the electronic device to perform wireless communication in full WLAN frequency band.

The frequency band of the radio frequency signal radiated by the closed-loop gap 13 and the frequency band of the radio frequency signal radiated by the first conductor 11 may be controlled by adjusting at least one of the size parameter of the first conductor 11, the size parameter of the second conductor 12, the size parameter of the closed-loop gap 13, the position parameter of the feeding point 110 on the first conductor 11, and the position parameter of the first grounding point 111 on the first conductor 11, such that the closed-loop gap 13 and the first conductor 11 may radiate radio frequency signals of same frequency band, or the closed-loop gap 13 and the first conductor 11 may radiate radio frequency signals of different frequency bands.

In the electronic device provided in embodiments of the present disclosure, the closed-loop gap 13 may be constructed as the clearance area of the first conductor 11. The closed-loop gap 13 may be configured as the clearance area of the first conductor 11 by adjusting at least one of the shape parameter and the size parameter of the closed-loop gap 13. In one embodiment, on the one hand, the first radiator may be formed based on the closed-loop gap 13, and the radio frequency signals may be radiated based on the closed-loop gap 13; on the other hand, the closed-loop gap 13 may be reused as the clearance area of the first conductor 11, and the closed-loop gap 13 may be used as the clearance area of the second radiator.

Therefore, based on the electronic device provided in embodiments of the present disclosure, when the closed-loop gap 13 is constructed as the clearance area of the first conductor 11, the closed-loop gap 13 may be reused as an antenna radiator based on same closed-loop gap 13, and the closed-loop gap 13 may also be configured as the clearance area of another antenna radiator, thereby improving the integration of the antennas in the electronic device. There is no need to add additional structures and materials in the electronic device, which may improve the compactness and aesthetics of the electronic device.

In embodiments of the present disclosure, an open-circuit branch of a part of the antenna may be added to the antenna feeder 14 according to the frequency band of the radio frequency signal required to be radiated in the electronic device to adjust the frequency band of the radio frequency signal.

Referring to FIG. 2, FIG. 2 illustrates another structural schematic of an electronic device according to various embodiments of the present disclosure. Based on any of above-mentioned implementation manners, in the electronic device shown in FIG. 2, the first conductor 11 may be a part of the housing 10 of the electronic device, the second conductor 12 may be another part of the housing 10 of the electronic device, the second conductor 12 may be electrically connected to a connection point characterizing a reference ground of the electronic device, and the second conductor 12 may be connected to two ends of the first conductor 11.

The second conductor 12 may be connected to the first grounding point 111 to provide a grounding potential for the first conductor 11; and the second conductor 12 may be connected to a structural part characterizing the reference ground of the electronic device, such that the second conductor 12 may be electrically connected to the connection point characterizing the reference ground of the electronic device. It should be noted that the reference ground in the electronic device may be any structural part in the electronic device that can provide a reference potential, which may not be limited in the present disclosure.

In one embodiment shown in FIG. 2, the electronic device may have two radiators based on the first conductor 11, the second conductor 12 in the housing 10 of the electronic device and the closed-loop gap 13 between the two conductors. As mentioned above, the two radiators may be the first radiator and the second radiator, respectively. The electronic device may radiate radio frequency signals based on the first radiator and the second radiator simultaneously. In such way, when the closed-loop gap 13 is blocked, the electronic device may also radiate radio frequency signals through the second radiator to ensure the performance of the antenna in the electronic device, thereby ensuring the wireless communication performance of the electronic device.

Optionally, the housing 10 may be a full metal housing, such that the housing 10 may include the first conductor 11, the second conductor 12 and the closed-loop gap 13. In other embodiments, the housing 10 may also be a partial metal housing, and the surrounding area of the housing 10 corresponding to the closed-loop gap 13 may be made of metal material, such that the housing 10 may include the first conductor 11, the second conductor 12 and the closed-loop gap 13.

In one embodiment shown in FIG. 2, the electronic device may use two different parts of the housing 10 as the first conductor 11 and the second conductor 12 and the closed-loop gap 13 may be formed based on the first conductor 11 and the second conductor 12. In such way, the antenna performance as described above may be improved, and there is no need to add other structural parts to the electronic device to form the first conductor 11, the second conductor 12 and the closed-loop gap 13. Therefore, the internal layout space of the electronic device may not need to be additionally occupied, and the volume of the electronic device may not be increased, thereby improving the integration of the electronic device.

When the first conductor 11 is a part of the housing 10 of the electronic device and the second conductor 12 is another part of the housing 10 of the electronic device, the electronic device may be shown as in FIG. 2, and the feeding point 110 and the first grounding point 111 may be configured to be respectively located at two ends of the first conductor 11. In an implementation manner, for the first conductor 11 with a certain length, the conductor with a relatively larger length may be configured between the first grounding point 111 and the feeding point 110; and the frequency band of the radio frequency signal radiated by the first conductor 11 may be controlled by setting the distance between the first grounding point 111 and the feeding point 110.

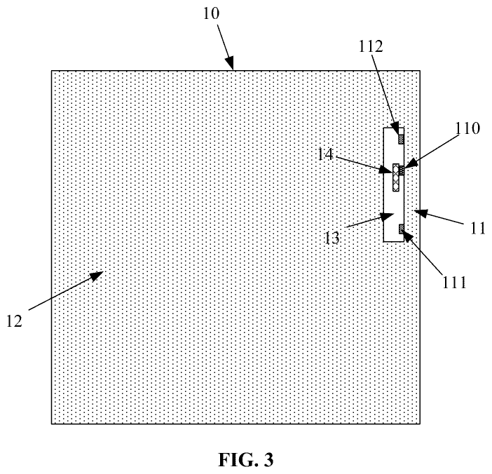

When the first conductor 11 is a part of the housing 10 of the electronic device and the second conductor 12 is another part of the housing 10 of the electronic device, the electronic device may also be as shown in FIG. 3.

Referring to FIG. 3, FIG. 3 illustrates another structural schematic of an electronic device according to various embodiments of the present disclosure. In the electronic device shown in an implementation manner, the first conductor 11 may be configured to also include a second grounding point 112; the second grounding point 112 and the first grounding point 111 may be located at two ends of the first conductor 11 respectively; the feeding point 110 may be located between the first grounding point 111 and the second grounding point 112; and in the first conductor 11, the part from the feeding point 110 to the first grounding point 111 may be configured to radiate the first radio frequency signal, and the part from the feeding point 110 to the second grounding point 112 may be configured to radiate the second radio frequency signal.

In the electronic device shown in FIG. 3, by setting two grounding points and one feeding point 110 in the first conductor 11, the first conductor 11 may be divided into two radiators, such that the part from the feeding point 110 to the first grounding point 111 may be configured to radiate the first radio frequency signal, and the part from the feeding point 110 to the second grounding point 112 may be configured to radiate the second radio frequency signal.

In embodiments of the present disclosure, the frequency bands of the first radio frequency signal and the second radio frequency signal may be configured to be same, which may improve the strength and stability of the radio frequency signals radiated by the electronic device through the first conductor 11.

In embodiments of the present disclosure, the frequency bands of the first radio frequency signal and the second radio frequency signal may also be configured to be different, which may increase the bandwidth of the radio frequency signals radiated by the electronic device through the first conductor 11. In such way, the electronic device may perform wireless communication on the first radio frequency signal and the second radio frequency signal of different frequency bands, thereby improving the wireless communication capability and flexibility of the electronic device. For example, the first radio frequency signal and the second radio frequency signal may be configured to correspond to different WIFI frequency bands respectively, which may achieve full coverage communication in the WIFI frequency bands.

When the frequency bands of the first radio frequency signal and the second radio frequency signal are different, the electronic device may also perform different functions based on the first radio frequency signal and the second radio frequency signal. For example, voice or video remote communication may be performed based on one of the first radio frequency signal and the second radio frequency signal; and positioning the electronic device or transmitting Bluetooth data and the like may be performed based on another one of the first radio frequency signal and the second radio frequency signal.

The frequency bands of the first radio frequency signal and the second radio frequency signal may be controlled by adjusting at least one of the length parameter of the first conductor 11, the position parameters of two grounding points in the first conductor 11, and the position parameter of the feeding point 110 in the first conductor 11, such that the frequency bands of the first radio frequency signal and the second radio frequency signal are same or different.

When the frequency bands of the first radio frequency signal and the second radio frequency signal are different, the first radio frequency signal and the second radio frequency signal may be operated in required frequency range respectively by adjusting at least one of the length parameter of the first conductor 11, the position parameters of two grounding points in the first conductor 11, and the position parameter of the feeding point 110 in the first conductor 11, such that the first radio frequency signal and the second radio frequency signal may not interfere with each other, and the electronic device may have desirable performance when performing different functions based on the first radio frequency signal and the second radio frequency signal respectively.

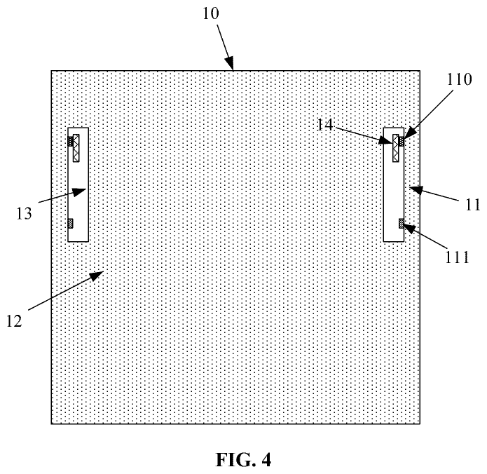

Referring to FIG. 4, FIG. 4 illustrates another structural schematic of an electronic device according to various embodiments of the present disclosure. On the basis of any of above implementation manners, the electronic device shown in FIG. 4 may include a plurality of first conductors 11; the plurality of first conductors 11 may be at least a part of the housing 10 of the electronic device; the second conductor 12 may be connected to two ends of each of the plurality of first conductors 11; and a plurality of closed-loop gaps 13 may be between the plurality of first conductors 11 and at least a part of the second conductors 12.

When the electronic device includes the plurality of first conductors 11, the plurality of first conductors 11 may be different parts of the housing 10. The second conductor 12 and each first conductor 11 may be different parts of the housing 10. Two ends of each first conductor 11 may be connected to same second conductor 12, such that each first conductor 11 may form the closed-loop gap 13 with same second conductor 12.

In one embodiment shown in FIG. 4, the plurality of first conductors 11, the second conductor 12, and the plurality of closed-loop gaps 13 corresponding to the plurality of first conductors 11 may be formed based on the housing 10 of the electronic device, such that the electronic device may have a plurality of first radiators and a plurality of second radiators.

Among the plurality of first radiators, the closed-loop gaps 13 may radiate the radio frequency signals together, such that each first radiator may radiate the radio frequency signals of same frequency band; that is, each closed-loop gap 13 may radiate the radio frequency signals of same frequency band. In such way, MIMO (multiple input multiple output communication) may be performed based on the plurality of first radiators, which may improve the throughput of the radio frequency signal of the electronic device in such frequency band.

Among the plurality of second radiators, the first conductor 11 may radiate radio frequency signals together, such that each second radiator may radiate radio frequency signals of same frequency band; that is, each first conductor 11 may radiate radio frequency signals of same frequency band. In such way, MIMO may be performed based on the plurality of second radiators, which may improve the throughput of radio frequency signals of the electronic device in such frequency band.

The electronic device may be configured with N first conductors 11 and one second conductor 12; and N closed-loop gaps 13 may be formed based on the N first conductors 11 and one second conductor 12, where N is a positive integer.

In response to that the electronic device is a foldable device, the electronic device may be configured to have two parts folded relative to each other. N first conductors and corresponding N closed-loop gaps 13 may be configured to be in same part of the electronic device. When N>1, at least one first conductor 11 and corresponding closed-loop gap 13 may be configured to be in a part of the electronic device; and other first conductors 11 and corresponding closed-loop gaps 13 may be configured to be in another part of the electronic device.

It should be noted that when the electronic device is a foldable device, the

electronic device may be not limited to be a two-part folding structure. The electronic device may also be configured to include M parts arranged in sequence, where M is greater than 2; and two adjacent parts in the electronic device may be folded.

Optionally, N=2 may be configured, that is, the electronic device may include two first conductors 11; and two closed-loop gaps 13 may be formed accordingly. The two first conductors 11 may be mirror-configured. At this point, the two first conductors 11 may be symmetrically arranged on two sides of the second conductor 12, and corresponding two closed-loop gaps 13 may be symmetrically arranged on two sides of the second conductor 12.

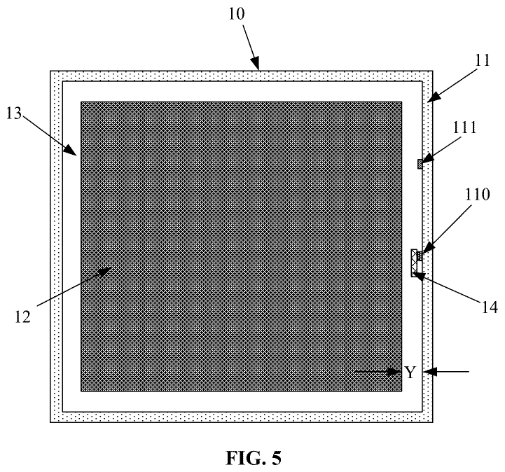

As disclosed above, in embodiments of the present disclosure, the first conductor 11 and the second conductor 12 may be formed by the housing 10 of the electronic device. In other embodiments, as shown in FIG. 5, the housing 10 of the electronic device may also be configured as the first conductor 11, and a functional module in the electronic device may be configured as the second conductor 12.

Referring to FIG. 5, FIG. 5 illustrates another structural schematic of an electronic device according to various embodiments of the present disclosure. In the electronic device shown in an implementation manner, the first conductor 11 may be the housing 10 of the electronic device; the second conductor 12 may be the functional module of the electronic device; the second conductor 12 may be electrically connected to the connection point characterizing the reference ground of the electronic device; and the first conductor 11 may be constructed as a surrounding-shaped structure configured to radiate radio frequency signals. For example, the surrounding-shaped structure may be a circle, a ring, a rectangle, a square, a polygon or the like.

The first conductor 11 with the surrounding-shaped structure may provide a more uniform radiation pattern, such that the electronic device may radiate radio frequency signals more effectively in more directions and further reduce the influence on the antenna performance in the electronic device when the closed-loop gap 13 is blocked.

In one embodiment shown in FIG. 5, the first conductor 11 may be the housing 10 of the electronic device, and the second conductor 12 may be the functional module of the electronic device. Same as above-mentioned embodiments, the closed-loop gap 13 may be between the first conductor 11 and at least a part of the second conductor 12 in the electronic device shown in FIG. 5; and the antenna feeder 14 may be electrically connected to the feeding point 110, such that the antenna feeder 14 may be electrically connected to the part of the electronic device forming the closed-loop gap 13, the closed-loop gap 13 may be configured to radiate radio frequency signals, and at least a part of the first conductor 11 may be configured to radiate radio frequency signals.

When the housing 10 of the electronic device is configured as the first conductor 11 and the functional module in the electronic device is configured as the second conductor 12, the electronic device may include both the first radiator and the second radiator, and the electronic device may radiate radio frequency signals based on the first radiator and the second radiator at same time. In such way, when the closed-loop gap 13 is blocked, the radio frequency signals may also be radiated through the second radiator, which may ensure the performance of the antenna in the electronic device and further ensure the wireless communication performance of the electronic device.

Optionally, in one embodiment shown in FIG. 5, the housing 10 may include a metal frame of a surrounding-shaped structure which may be configured as the first conductor 11. The metal frame may surround the functional module configured as the second conductor 12, which may be convenient for forming the closed-loop gap 13 between the metal frame and the functional module.

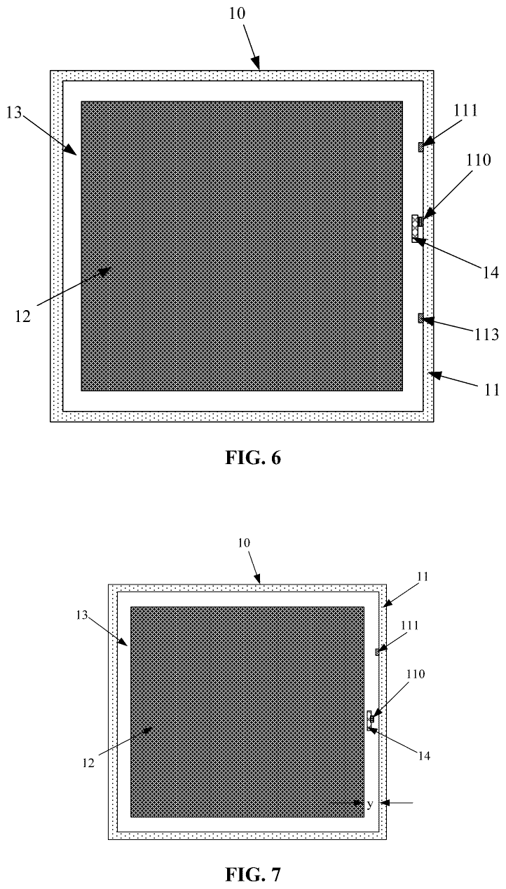

Referring to FIG. 6, FIG. 6 illustrates another structural schematic of an electronic device according to various embodiments of the present disclosure. On the basis of one embodiment shown in FIG. 5, in the electronic device shown in FIG. 6, the first conductor 11 may further include a third grounding point 113; the current direction from the feeding point 110 to the first grounding point 111 may be the first direction; the current direction from the feeding point 110 to the third grounding point 113 may be the second direction; the first direction may be opposite to the second direction; and on the first conductor 11, the part from the feeding point 110 to the first grounding point 111 may be configured to radiate the third radio frequency signal, and the part from the feeding point 110 to the third grounding point 113 may be configured to radiate the fourth radio frequency signal.

In one embodiment shown in FIG. 6, the first grounding point 111 and the third grounding point 113 may be simultaneously configured in the housing 10 with same surrounding-shaped structure; the feeding point 110 may be configured between the first grounding point 111 and the third grounding point 113; and two opposite current directions may be generated in the housing 10 with same surrounding-shaped structure. In such way, two independent radiation parts may be formed by the housing 10 with same surrounding-shaped structure and configured to radiate the third radio frequency signal and the fourth radio frequency signal respectively, such that the electronic device may simultaneously radiate the third radio frequency signal and the fourth radio frequency signal based on the housing 10 with same surrounding-shaped structure.

In an implementation manner of embodiments of the present disclosure, the frequency bands of the third radio frequency signal and the fourth radio frequency signal may be configured to be same. At this point, the electronic device may simultaneously radiate the third radio frequency signal and the fourth radio frequency signal of same frequency band based on the housing 10 with same surrounding-shaped structure, which may improve the radio frequency signal strength and stability of the electronic device when performing wireless communication in the frequency band.

In one implementation of embodiments of the present disclosure, the frequency bands of the third radio frequency signal and the fourth radio frequency signal may also be configured to be different. At this point, the electronic device may simultaneously radiate the third radio frequency signal and the fourth radio frequency signal with different frequency bands based on the housing 10 with same surrounding-shaped structure, which may improve the bandwidth of the radio frequency signal radiated by the electronic device through the first conductor 11. Therefore, the electronic device may perform wireless communication on the third radio frequency signal and the fourth radio frequency signal of different frequency bands, thereby improving the wireless communication capability and flexibility of the electronic device.

The frequency bands of the third radio frequency signal and the fourth radio frequency signal may be controlled by adjusting at least one of the distance parameter y between the housing 10 and the functional module (i.e., the width of the closed-loop gap 13), the length parameter of the first conductor 11 between the grounding point and the feeding point 110, the position parameter of the feeding point 110 on the first conductor 11, and the position parameter of the grounding point on the first conductor 11, which may optimize the frequency bands, signal coverage and quality of the third radio frequency signal and the fourth radio frequency signal, thereby enabling the electronic device to operate on more frequency bands and improving the performance and flexibility of wireless communication.

In the electronic device provided in any of above-mentioned embodiments, it may configure that the antenna feed 14 may be coupled with the closed-loop gap 13 for feeding, and the antenna feed 14 may be coupled with the feeding point 110 for feeding; and it may also configure that the antenna feed 14 may be coupled with the closed-loop gap 13 for feeding, and the antenna feed 14 and the feeding point 110 may be directly used for feeding.

When the antenna feeder 14 and the feeding point 110 are directly used for feeding, the antenna feeder 14 and the feeding point 110 may be configured to have a contact electrical connection. At this point, the feeding point 110 and the housing 10 may be configured to have a contact electrical connection as shown in FIGS. 1-6, or the feeding point 110 may be configured to be coupled with the housing 10 for feeding as shown in FIG. 7.

Referring to FIG. 7, FIG. 7 illustrates another structural schematic of an electronic device according to various embodiments of the present disclosure. In an implementation manner, the feeding point 110 may be configured between the housing 10 and the functional module; a gap may be between the feeding point 110 and the housing 10; and the antenna feeder 14 and the feeding point 110 may have a contact electrical connection.

When the antenna feeder 14 is coupled with the feeding point 110 for feeding, the structure of the electronic device may be as shown in FIG. 8.

Referring to FIG. 8, FIG. 8 illustrates another structural schematic of an electronic device according to various embodiments of the present disclosure. In an implementation manner, the feeding point 110 may be on the housing 10; a gap may be between the feeding point 110 and the antenna feeder 14; and the antenna feeder 14 may be coupled with the feeding point 110 for feeding based on the gap.

The feeding manner of the antenna feeder 14 and the closed-loop gap 13 and the feeding manner of the antenna feeder 14 and the feeding point 110 may be selected based on the circuit layout requirement in the electronic device, which may not be limited in embodiments of the present disclosure.

It should be noted that in embodiments shown in FIGS. 5-8, only the feeding manner in the electronic device is described when the second conductor 12 is formed based on the functional module. Above feeding manners may be also applicable to implementation manners of the second conductor 12 formed based on the housing 10, which may not be illustrated separately in embodiments of the present disclosure.

In an implementation manner of embodiments of the present disclosure, as shown in any of implementation manners of FIGS. 1-8, o part of the antenna feed 14 may be configured to be overlapped with the closed-loop gap 13, and such part of the antenna feed 14 may be exposed based on the closed-loop gap 13. At this point, one part of the antenna feed 14 may be located inside the housing 10, and the one part of the antenna feed 14 may be blocked by the first conductor 11 and/or the second conductor 12; and another part of the antenna feed 14 may be overlapped with the closed-loop gap 13, and the one part of the antenna feed 14 may be exposed based on the closed-loop gap 13.

In other implementation manners, the antenna feeder 14 may be not overlapped with the closed-loop gap 13. At this point, entire antenna feeder 14 may be located inside the housing 10; and entire antenna feeder 14 may be blocked by the first conductor 11 and/or the second conductor 12. In an implementation manner, the antenna feeder 14 may be configured to be adjacent to the closed-loop gap 13 inside the housing 10, such that the antenna feeder 14 may, based on the closed-loop gap 13, form the first radiator to radiate radio frequency signals based on the closed-loop gap 13.

In an implementation manner of embodiments of the present disclosure, when the second conductor 12 is formed based on the functional module, the functional module may be any one of a display module, an audio module, and a camera module of the electronic device. In such implementation manner, the housing 10 of the electronic device may be reused to form the first conductor 11; and any one of the electronic devices including the display module, audio module, and camera module may be reused as the second conductor 12. Additional structural parts or materials may not need to be added in the electronic device for forming the first conductor 11 and the second conductor 12, which may not increase the volume of the electronic device, improve the integration of the electronic device, and enable the electronic device to have lower production cost.

The electronic device may include a display module; the display module may include pixels for image display; and the display module may also include at least one layer of backlight metal away from the light-emitting side of the pixels, and the backlight metal may be configured as at least one of a support layer, a heat dissipation layer, and an electromagnetic shielding layer in the display module. When the functional module is the display module, the backlight metal in the functional module may characterize the connection point of the reference ground of the electronic device. In such implementation manner, the backlight metal in the functional module may be reused as the connection point of the reference ground of the electronic device, and a separate metal layer may not need to be added, which may reduce the thickness of the electronic device.

The electronic device may include an audio module; and the audio module may include an audio control circuit board and a speaker assembly fixed on the audio control circuit board. When the functional module is the audio module, the metal layer in the audio control circuit board may characterize the connection point of the reference ground of the electronic device. In such implementation manner, the metal layer in the audio control circuit board may be reused as the connection point of the reference ground of the electronic device, and a separate metal layer may not need to be added, which may reduce the thickness of the electronic device.

The electronic device may include a camera module; the camera module may include a camera control circuit board and a photosensitive chip fixed on the camera control circuit board; and a lens assembly may be configured on the light-entering side of the photosensitive chip. The lens assembly may be fixed above the photosensitive chip based on the housing; and a filter may be configured between the photosensitive chip and the lens assembly to reduce stray light interference. When the functional module is the camera module, the metal layer in the camera control circuit board may characterize the connection point of the reference ground of the electronic device. In such implementation manner, the metal layer in the camera control circuit board may be reused as the connection point of the reference ground of the electronic device, and a separate metal layer may not need to be added, which may reduce the thickness of the electronic device.

Optionally, when the second conductor 12 is formed based on the functional module in the electronic device, the reference ground of the electronic device may be a metal structural part of the functional module, or a circuit-board main ground in a circuit board of the electronic device.

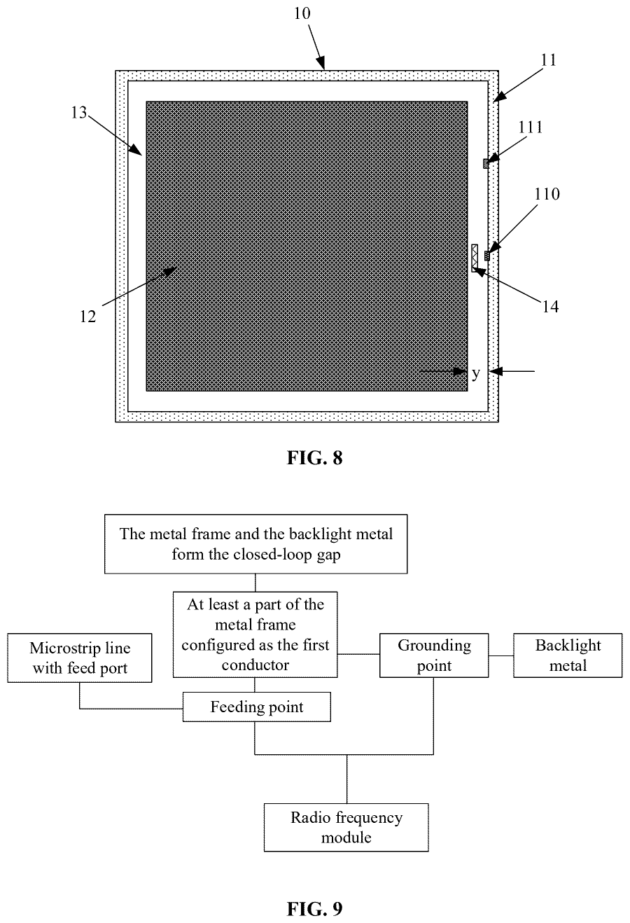

Taking the housing 10 including the metal frame and the functional module including the backlight metal as an example, when the first conductor 11 is formed based on the metal frame and the backlight metal is configured as the reference ground, the composition principle of the antenna in the electronic device may be as shown in FIG. 9.

FIG. 9 illustrates a principle schematic of an antenna in the electronic device according to various embodiments of the present disclosure. The electronic device may include a radio frequency module and a microstrip line with a feed port. The radio frequency module may include above-mentioned antenna feeder 14. The radio frequency module and the microstrip line with the feed port may be electrically connected to the feeding point 110, respectively. The closed-loop gap 13 may be formed between the metal frame and the backlight metal; and at least a part of the metal frame may be configured as the first conductor 11. At least a part of the metal frame as the first conductor 11 may be connected to the feeding point 110 and corresponding grounding point, respectively; and the grounding point may be electrically connected to the backlight metal configured as the reference ground. Other structural parts may be electrically connected to the feeding point 110 for direct feeding or coupled feeding.

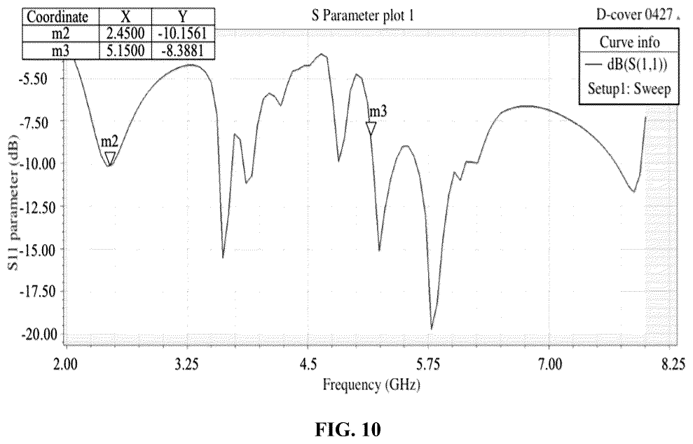

As shown in FIG. 10, experimental data show that, based on the electronic device provided by embodiments of the present disclosure, the communication bandwidth of the antenna in the electronic device may be improved.

FIG. 10 illustrates a curve diagram of an input reflection coefficient S11 (or “S (1, 1)”) parameter of an antenna in the electronic device according to various embodiments of the present disclosure. The horizontal axis X is the frequency in the unit of GHz, and the vertical axis Y is the S11 parameter in the unit of dB. Based on the simulation data of two data coordinate points of m2 (2.4500, −10.1561) and m3 (5.1500, −8.3881), it may be seen that the width of the antenna may be relatively large, which may achieve full coverage of the WIFI frequency band.

Embodiments of the present disclosure provide a configuring method of an electronic device. The method includes forming a first conductor and a second conductor, where the first conductor is a part of a housing of the electronic device, and the second conductor is another part of the housing of the electronic device, or the first conductor is the housing of the electronic device, and the second conductor is a functional module of the electronic device; and a closed-loop gap is between the first conductor and at least a part of the second conductor, and the first conductor includes a feeding point and a first grounding point; and forming an antenna feeder, coupled with the closed-loop gap for feeding or in a direct contact with the feeding point for feeding, where the closed-loop gap is configured to radiate a radio frequency signal, and at least a part of the first conductor is configured to radiate a radio frequency signal.

In the present disclosure, each embodiment is described in a progressive, parallel, or progressive and parallel manner. Each embodiment focuses on the differences from other embodiments; and same and similar parts between embodiments may be referred to each other.

It should be noted that in the description of the present disclosure, it should be understood that the description of the drawings and embodiments may be illustrative rather than restrictive. Same drawing marks throughout embodiments of the present disclosure may identify same structures. Furthermore, for the sake of understanding and ease of description, the drawings may exaggerate the thickness of some layers, films, panels, regions and the like. It should be also understood that when an element such as a layer, film, region or substrate is referred to as “on” another element, the element may be directly on the other element or there may be an intermediate element. In addition, “on” may refer to positioning an element on or below another element but may not essentially refer to positioning an element on the upper side of another element according to the direction of gravity.

It should be noted that, in the description of the present disclosure, it should be understood that orientation or positional relationship indicated by the terms “on”, “below”, “top”, “bottom”, “inside”, “outside” and the like may be based on the orientation or positional relationship shown in the drawings, which may be merely for the convenience of describing the present disclosure and simplifying the description, rather than indicating or implying that indicated device or element must have a specific orientation, be constructed and operated in a specific orientation; therefore, it should not be understood as a limitation on the present disclosure. When a component is “connected” to another component, the component may be directly connected to another component, or an intermediate component may be between above components.

It should also be noted that in the present disclosure, relational terms such as first, second and the like may be merely configured to distinguish one entity or operation from another entity or operation and may not necessarily require or imply any such actual relationship or order between above entities or operations. Moreover, the terms “include”, “contain” or any other variations thereof may be intended to cover non-exclusive inclusion, such that an article or equipment that includes a series of elements may not only include those elements, but also other elements that are not explicitly listed, or also include elements inherent to the article or equipment. If there are no more restrictions, the elements defined by the sentence “include a . . . ” may not exclude the existence of other same elements in the article or equipment that includes above elements.

Above description of disclosed embodiments may enable those skilled in the art to make or use the present disclosure. Various modifications to disclosed embodiments may be readily apparent to those skilled in the art, and the generic principles defined herein may be implemented in other embodiments without departing from the spirit or scope of the present disclosure. Therefore, the present disclosure may not be intended to be limited to embodiments of the present disclosure but may be accorded the widest scope consistent with the principles and novel features disclosed herein.

What is claimed is:

1. An electronic device, comprising:
a first conductor and a second conductor, wherein the first conductor is a part of a housing of the electronic device, and the second conductor is another part of the housing of the electronic device; and a closed-loop gap is between the first conductor and at least a part of the second conductor, and the first conductor includes a feeding point and a first grounding point; and
an antenna feeder, coupled with the closed-loop gap for feeding or in a direct contact with the feeding point for feeding, wherein the closed-loop gap is configured to radiate a radio frequency signal, and at least a part of the first conductor is configured to radiate a radio frequency signal.

2. The electronic device according to claim 1, wherein:
the radio frequency signal radiated by the closed-loop gap is in a same frequency band as the radio frequency signal radiated by the first conductor; or
the radio frequency signal radiated by the closed-loop gap is in a different frequency band from the radio frequency signal radiated by the first conductor.

3. The electronic device according to claim 1, wherein:
the second conductor is electrically connected to a connection point characterizing a reference ground of the electronic device and connected to two ends of the first conductor.

4. The electronic device according to claim 3, wherein:
the feeding point and the first grounding point are respectively at the two ends of the first conductor; or
the first conductor further includes a second grounding point; the second grounding point and the first grounding point are respectively at the two ends of the first conductor; the feeding point is between the first grounding point and the second grounding point; and a part of the first conductor from the feeding point to the first grounding point is configured to radiate a first radio frequency signal, and a part of the first conductor from the feeding point to the second grounding point is configured to radiate a second radio frequency signal.

5. The electronic device according to claim 3, wherein:
the electronic device includes a plurality of first conductors; the plurality of first conductors is at least a part of the housing of the electronic device; and the second conductor is connected to two ends of each of the plurality of first conductors; and
a plurality of closed-loop gaps is between the plurality of first conductors and at least a part of the second conductor.

6. The electronic device according to claim 1, wherein:
the closed-loop gap is constructed as a clearance area of the first conductor.

7. An electronic device, comprising:
a first conductor and a second conductor, wherein the first conductor is the housing of the electronic device, and the second conductor is a functional module of the electronic device; and a closed-loop gap is between the first conductor and at least a part of the second conductor, and the first conductor includes a feeding point and a first grounding point; and
an antenna feeder, fed with the closed-loop gap by coupling with the feeding point or by a direct contact with the feeding point, wherein the closed-loop gap is configured to radiate a radio frequency signal, and at least a part of the first conductor is configured to radiate a radio frequency signal.

8. The electronic device according to claim 7, wherein:
the second conductor is electrically connected to a connection point characterizing a reference ground of the electronic device; and
the first conductor is constructed as a surrounding-shaped structure configured to radiate the radio frequency signal.

9. The electronic device according to claim 8, wherein:
the first conductor further includes a third grounding point; a current direction from the feeding point to the first grounding point is a first direction, and a current direction from the feeding point to the third grounding point is a second direction; the first direction is opposite to the second direction; and
a part of the first conductor from the feeding point to the first grounding point is configured to radiate a third radio frequency signal, and a part of the first conductor from the feeding point to the third grounding point is configured to radiate a fourth radio frequency signal.

10. The electronic device according to claim 8, wherein:
the functional module is any one of a display module, an audio module, and a camera module of the electronic device; and
when the functional module is the display module, a backlight metal of the functional module characterizes the connection point of the reference ground of the electronic device.

11. The electronic device according to claim 10, wherein:
when the functional module is the audio module, a metal layer of an audio control circuit board characterizes the connection point of the reference ground of the electronic device.

12. A method of configuring an electronic device, comprising:
configuring a first conductor and a second conductor, wherein the first conductor is a part of a housing of the electronic device, and the second conductor is another part of the housing of the electronic device, or the first conductor is the housing of the electronic device, and the second conductor is a functional module of the electronic device; and a closed-loop gap is between the first conductor and at least a part of the second conductor, and the first conductor includes a feeding point and a first grounding point; and
providing an antenna feeder, coupled with the closed-loop gap for feeding or in a direct contact with the feeding point for feeding, wherein the closed-loop gap is configured to radiate a radio frequency signal, and at least a part of the first conductor is configured to radiate a radio frequency signal.

13. The method according to claim 12, wherein:
the radio frequency signal radiated by the closed-loop gap is in a same frequency band as the radio frequency signal radiated by the first conductor; or
the radio frequency signal radiated by the closed-loop gap is in a different frequency band from the radio frequency signal radiated by the first conductor.

14. The method according to claim 12, wherein:
the first conductor is the part of the housing of the electronic device, the second conductor is another part of the housing of the electronic device; and
the second conductor is electrically connected to a connection point characterizing a reference ground of the electronic device and connected to two ends of the first conductor.

15. The method according to claim 14, wherein:
the feeding point and the first grounding point are respectively at the two ends of the first conductor; or
the first conductor further includes a second grounding point; the second grounding point and the first grounding point are respectively at the two ends of the first conductor; the feeding point is between the first grounding point and the second grounding point; and a part of the first conductor from the feeding point to the first grounding point is configured to radiate a first radio frequency signal, and a part of the first conductor from the feeding point to the second grounding point is configured to radiate a second radio frequency signal.

16. The method according to claim 14, wherein:
the electronic device includes a plurality of first conductors; the plurality of first conductors is at least a part of the housing of the electronic device; and the second conductor is connected to two ends of each of the plurality of first conductors; and
a plurality of closed-loop gaps is between the plurality of first conductors and at least a part of the second conductor.

17. The method according to claim 12, wherein:
the closed-loop gap is constructed as a clearance area of the first conductor.

18. The method according to claim 12, wherein:
the second conductor is electrically connected to a connection point characterizing a reference ground of the electronic device; and
the first conductor is constructed as a surrounding-shaped structure configured to radiate the radio frequency signal.

19. The method according to claim 13, wherein:
the first conductor further includes a third grounding point; a current direction from the feeding point to the first grounding point is a first direction, and a current direction from the feeding point to the third grounding point is a second direction; the first direction is opposite to the second direction; and
a part of the first conductor from the feeding point to the first grounding point is configured to radiate a third radio frequency signal, and a part of the first conductor from the feeding point to the third grounding point is configured to radiate a fourth radio frequency signal.

20. The method according to claim 13, wherein:
the functional module is any one of a display module, an audio module, and a camera module of the electronic device; and
when the functional module is the display module, a backlight metal of the functional module characterizes the connection point of the reference ground of the electronic device.
